(19) United States
(12) Patent Application Publication
(10) Pub. No.: US 2026/0093773 A1
(43) Pub. Date: Apr. 2, 2026

(54) INFORMATION PROCESSING APPARATUS, INFORMATION PROCESSING METHOD AND NON-TRANSITORY COMPUTER-READABLE STORAGE MEDIUM

(71) Applicant: CANON KABUSHIKI KAISHA, Tokyo (JP)

(72) Inventor: Shigeo KODAMA, Tokyo (JP)

(21) Appl. No.: 19/335,086

(22) Filed: Sep. 22, 2025

(30) Foreign Application Priority Data
Jul. 2, 2025 (JP) 2025-112523
Sep. 30, 2024 (JP) 2024-171514

(51) Int. Cl. G06F 17/15; G06N 3/0464; G06N 3/048

(52) U.S. Cl. CPC G06F 17/15; G06N 3/0464; G06N 3/048

(57) ABSTRACT

An information processing apparatus for performing a graph convolution operation on a graph comprises a first acquisition unit configured to acquire from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph, a second acquisition unit configured to acquire, based on the connection destination, data to be inputted into a computing unit from among computation target data, and a computation unit configured to use the computing unit to perform an operation using the data acquired by the second acquisition unit and the weight of node acquired by the first acquisition unit.

### BACKGROUND

### Field of the Technology

The present disclosure relates to a graph-based convolution operation technology.

### DESCRIPTION OF THE RELATED ART

With the development of deep learning technology, it is possible to analyze the molecular structures of compounds, social networks, natural language, and the like using data having a graph structure (hereinafter abbreviated as "graph"). For example, in Weijing Shi, Ragunathan (Raj) Rajkumar, "Point-GNN: Graph Neural Network for 3D Object Detection in a Point Cloud", The IEEE/CVF Conference on Computer Vision and Pattern Recognition, 2020, a technique is disclosed in which a graph is generated from point cloud data obtained by LiDAR, and a convolution operation using coefficients obtained by deep learning technology is hierarchically performed on the graph to detect an object. Further, as described in Japanese Patent Laid-Open No. 2020-87127, Thomas N. Kpf, Max Welling, "SEMI-SUPERVISED CLASSIFICATION WITH GRAPH CONVOLUTIONAL NETWORKS", The International Conference on Learning Representations, 2017, a technique for extracting more appropriate information from a graph is disclosed.

Japanese Patent Laid-Open No. 2020-87127 discloses a technique in which, when performing graph convolution operations, a product of a normalized adjacency matrix with self loops, a feature matrix that summarizes the feature data of each node constituting the graph, and a parameter matrix of a trained neural network is calculated. Meanwhile, an adjacency matrix (a matrix representing weights of edges connecting nodes) of a graph often has values of 0 (values indicating that nodes are not connected and that there is no weight for the edge) for most of the elements. Therefore, when calculating the product of the adjacency matrix and the other matrices, elements having the value 0 in the adjacency matrix are wastefully multiplied, thereby increasing power consumption and the processing time.

### SUMMARY

The present disclosure provides a technique for efficiently performing a convolution operation of a graph.

According to the first aspect of the present disclosure, there is provided an information processing apparatus for performing a graph convolution operation on a graph, the apparatus comprising: a first acquisition unit configured to acquire from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph; a second acquisition unit configured to acquire, based on the connection destination, data to be inputted into a computing unit from among computation target data; and a computation unit configured to use the computing unit to perform an operation using the data acquired by the second acquisition unit and the weight of node acquired by the first acquisition unit.

According to the second aspect of the present disclosure, there is provided an information processing method performed by an information processing apparatus for performing a graph convolution operation on a graph, the method comprising: acquiring from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph; acquiring, based on the connection destination, data to be inputted into a computing unit from among computation target data; and using the computing unit to perform an operation using the acquired data and the acquired weight of node.

According to the third aspect of the present disclosure, there is provided a non-transitory computer-readable storage medium storing a computer program for causing a computer operable to perform a graph convolution operation on a graph to function as: a first acquisition unit configured to acquire from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph; a second acquisition unit configured to acquire, based on the connection destination, data to be inputted into a computing unit from among computation target data; and a computation unit configured to use the computing unit to perform an operation using the data acquired by the second acquisition unit and the weight of node acquired by the first acquisition unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a hardware configuration of an information processing apparatus.

FIG. 2 is a block diagram illustrating an example of a hardware configuration of a computation unit 101.

FIG. 3A is a flowchart of processing performed by the information processing apparatus.

FIG. 3B is a flowchart of processing performed by the information processing apparatus.

FIG. 4A is a view illustrating a difference in the number of multiplications according to the matrix computation order.

FIG. 4B is a view illustrating a difference in the number of multiplications according to the matrix computation order.

FIG. 5 is a diagram illustrating an example of processing for generating an edge weight list.

FIG. 6A is a diagram for explaining an operation of the computation unit 101.

FIG. 6B is a diagram for explaining an operation of the computation unit 101.

FIG. 7 is a diagram illustrating a feature map and a feature vector.

FIG. 8 is a diagram illustrating feature vector graph structuring.

FIG. 9 is a diagram illustrating a network structure of a graph convolution operation.

FIG. 10A is a diagram illustrating a computation amount according to an order in computing matrix operations.

FIG. 10B is a diagram illustrating a computation amount according to an order in computing matrix operations.

FIG. 10C is a diagram illustrating a computation amount according to an order in computing matrix operations.

FIG. 10D is a diagram illustrating a computation amount according to an order in computing matrix operations.

FIG. 11A is a flowchart of processing performed by the information processing apparatus.

FIG. 11B is a flowchart of processing performed by the information processing apparatus.

FIG. 12A is a diagram for explaining an operation of the computation unit 101.

FIG. 12B is a diagram for explaining an operation of the computation unit 101.

FIG. 12C is a diagram for explaining an operation of the computation unit 101.

FIG. 13 is a conceptual diagram illustrating a method of generating an edge weight list.

FIG. 14 is a diagram for explaining an operation of the computation unit 101.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a case in which an information processing apparatus executes a task of categorizing papers by using a Cora dataset in which a paper citation relationship is graphically expressed will be described.

A Cora dataset (refer to the website at https://relational.fit.cvut.cz/dataset/CORA) is a graph composed of 2708 scientific papers, where each paper is one node, and 5429 edges indicate citing/cited relationships. In addition, in one node (paper), feature data is defined by values of 0 (non-appearance) and 1 (appearance) indicating whether or not 1433 words related to paper category determination appear. A graph representing this Cora dataset is inputted and each paper is classified into one of seven categories by two graph convolution layers.

For the computation of the two graph convolution layers used in the present embodiment, the convolution operation described in Thomas N. Kpf, Max Welling, "SEMI-SUPERVISED CLASSIFICATION WITH GRAPH CONVOLUTIONAL NETWORKS", The International Conference on Learning Representations, 2017 is used. An outline of application to the Cora dataset will be described. The data to be inputted in the present embodiment is a feature matrix X0 having a height 2708 and a width 1433, in which the number of nodes (the number of papers) is 2708 and there are 1433 pieces of the feature data for each node. In addition, since an adjacency matrix (a matrix representing edge weights) A of the graph indicates connection relationships between the nodes, the adjacency matrix A is a matrix having a height of 2708 and a width of 2708 and containing non-zero values only in elements having a citing/cited relationship. In processing the paper classification task, an adjacency matrix with self loops can be used, and non-zero values are normalized according to the degree (the number of edges connected to each node), to suppress large variations in the output range of the convolution result of each node.

In a first layer graph convolution operation, the computation of X1=Relu (A * X0 * W1) is performed using a parameter matrix W1, which has been trained by machine learning so that the number of input features is 1433 and the number of output features is 16. Here, Relu() is a nonlinear transformation function that clips negative values to 0, and processing for converting values by applying this function is referred to as Relu processing.

In a second layer graph convolution operation, the computation of X2=A * X1 * W2 is performed using a parameter matrix W2, which has been trained by machine learning so that the number of input features is 16 and the number of output features is 7.

In the task of the present embodiment, the seven outputted features each indicate the likelihood of the category of the paper, and classification is performed by assigning the category corresponding to the feature with the highest likelihood among these likelihoods as the category of the paper (node). Therefore, in the second layer graph convolution operation, a nonlinear transformation such as Relu() is not required.

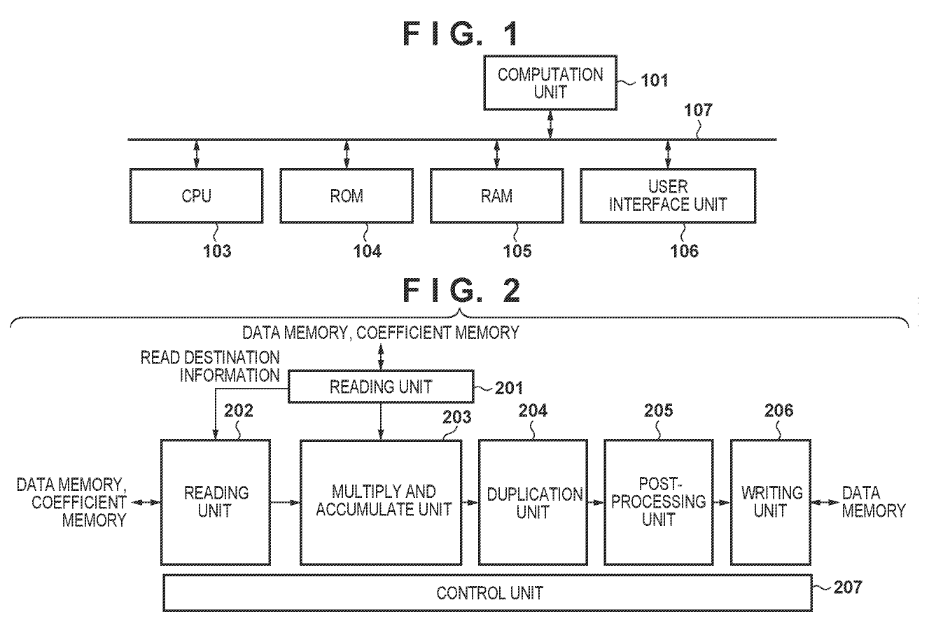

An example of a hardware configuration of an information processing apparatus functioning as a graph convolution apparatus having a computation unit for performing the above-described operations will be described with reference to a block diagram of FIG. 1. Note that the hardware configuration illustrated in FIG. 1 is only an example of a hardware configuration of an information processing apparatus applicable to the graph convolution apparatus, and can be modified/changed as appropriate.

A computation unit 101 performs a graph convolution operation on a graph, which is data having a graph structure, by performing an operation of each graph convolution layer. In the present embodiment, since two graph convolution layers are used, the computation unit 101 performs the operation of each of the two graph convolution layers.

A Central Processing Unit (CPU) 103 executes various processes using computer programs and data stored in a Random Access Memory (RAM) 105. As a result, the CPU 103 controls the operation of the entire information processing apparatus and executes or controls various processes described as processing performed by the information processing apparatus.

In the present embodiment, the CPU 103 performs a process of extracting classification categories from feature data after performing the operations of the two graph convolution layers. In the present embodiment, seven features (likelihoods) are computed as to which category each node (paper) should be classified as by the operations of the two graph convolution layers. The CPU 103 performs classification by assigning the category corresponding to the feature to the highest likelihood among the seven features as the category of the paper (node).

A Read Only Memory (ROM) 104 stores setting data of the information processing apparatus, computer programs and data related to activation of the information processing apparatus, computer programs and data related to basic operation of the information processing apparatus, and the like. The ROM 104 also stores computer programs and data for causing the CPU 103 and the computation unit 101 to execute or control various processes described as processes performed by the information processing apparatus.

The RAM 105 can be composed of a large-capacity Dynamic Random Access Memory (DRAM) or the like. The RAM 105 has an area for storing computer programs and data loaded from the ROM 104. Further, the RAM 105 has a work area used when the CPU 103 or the computation unit 101 executes various processes. As described above, the RAM 105 can provide various areas as appropriate.

For example, the RAM 105 functions as a data memory that holds feature data that is inputted when a graph convolution operation is executed in the computation unit 101, and intermediate feature data and output data generated in the graph convolution operation. In addition, the RAM 105 also functions as a coefficient memory that holds a "parameter matrix computed in advance by training" used in the graph convolution operation.

A user interface unit 106 is a user interface such as a keyboard and a mouse, and can input various instructions and information to the information processing apparatus by a user operation. Note that the user interface unit 106 may include a display device having a liquid crystal screen or a touch panel screen. For example, the user interface unit 106 may display a result of paper category classification, a Graphical User Interface (GUI) for selecting a process to be executed by the computation unit 101, and the like. The user can operate the GUI by operating the user interface unit 106.

The computation unit 101, the CPU 103, the ROM 104, the RAM 105, and the user interface unit 106 are all connected to a system bus 107. A computer device such as a PC (Personal Computer), a smart phone, a tablet terminal device, or the like can be applied to an information processing apparatus which has such a hardware configuration.

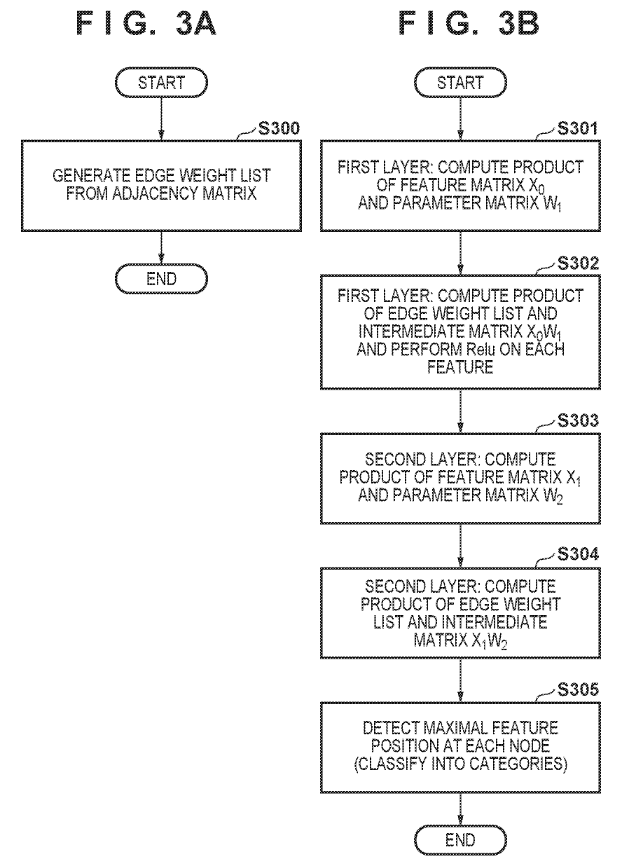

Next, a hardware configuration example of the above-described computation unit 101 will be described with reference to a block diagram of FIG. 2. A reading unit 201 reads a plurality of pieces of feature data from a feature matrix stored in a data memory in the RAM 105, and reads an edge weight list of the graph. A reading unit 202 reads a parameter matrix computed in advance by training, from a coefficient memory in the RAM 105.

A multiply and accumulate unit 203 performs a multiply-accumulate operation on the feature data read by the reading unit 201 and the coefficient data in the parameter matrix read by the reading unit 202.

A duplication unit 204 repeatedly outputs the result of the multiply-accumulate operation (multiply-accumulate operation result) by the multiply and accumulate unit 203 to a post-processing unit 205. The post-processing unit 205, in the graph convolution operation, performs processing such as a nonlinear transformation using the above-described Relu function. A writing unit 206 writes out the result of the processing performed by the post-processing unit 205 to a data memory in the RAM 105. A control unit 207 performs overall operation control of the computation unit 101, and performs control so that the data to be processed does not accumulate and degrade performance.

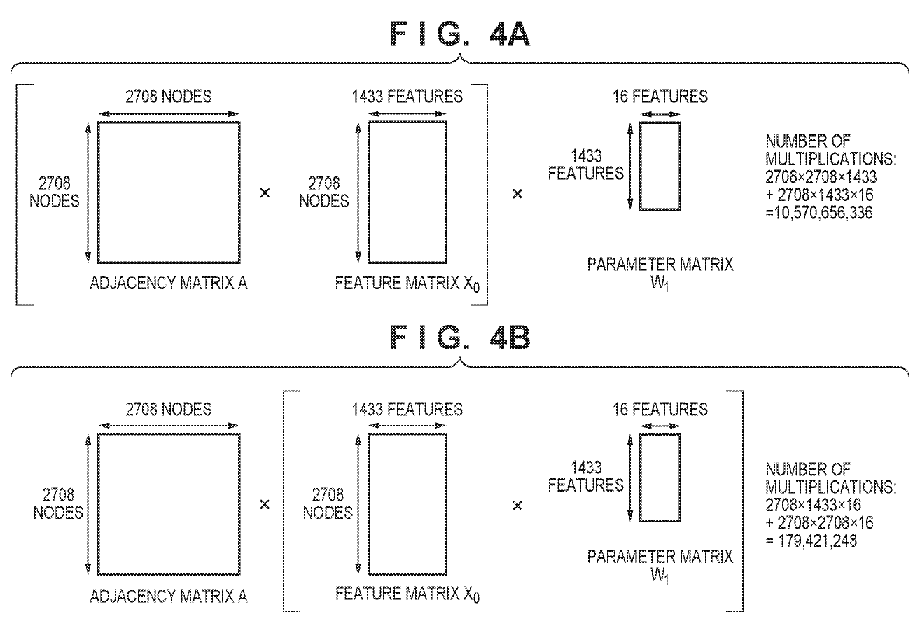

Next, the processing performed by the information processing apparatus will be described in accordance with the flowcharts of FIGS. 3A and 3B. First, preliminary preparatory processing performed prior to inference will be described in accordance with a flowchart of FIG. 3A.

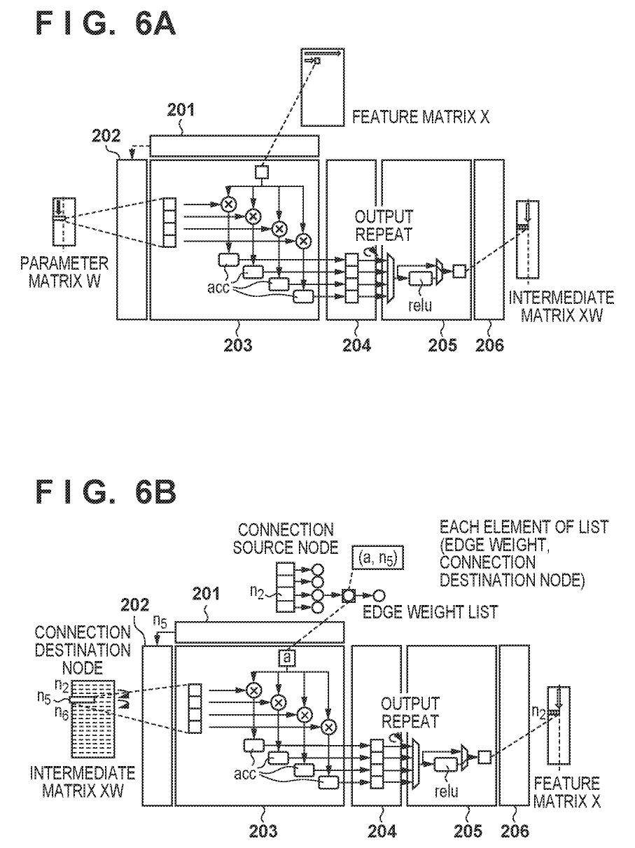

In step S300, the CPU 103 generates the edge weight list from the adjacency matrix. An example of a process for generating the edge weight list from the adjacency matrix will be described with reference to FIG. 5.

In general, graph adjacency matrices have many elements with a value of 0, and in FIG. 5, only elements indicated by black rectangles have non-zero edge weights. Also, in an adjacency matrix with self loops, an element having a non-zero value appears in a diagonal component. An edge weight list is generated from the adjacency matrix. The edge weight list has a structure in which elements corresponding to edge weights having a non-zero value are listed for each of the connection source nodes. In each element, an edge weight having a non-zero value and a connection destination node form a pair. As a result, it is possible to access in order, from the connection source node, only connection destination nodes having non-zero valued edge weights (that is, those for which there is a connection relationship between the nodes). With this method of expressing the edge weight list, the sparser adjacency matrix (the ratio of elements having a value of 0), the more the data amount can be compressed. In the present embodiment, in the case of the Cora dataset, the adjacency matrix has 2708×2708 components, whereas the edge weight list has 13556 (the number of edges 5429×2+2708) elements.

It should be noted that the processing of step S300 need only be performed once in a case where the adjacency matrix is determined in advance, and may be performed by the CPU 103, or may be performed by another apparatus. The generated edge weight list is stored in the data memory of the RAM 105 prior to performing inference.

Next, an operation (a two-layer convolution operation) in the two graph convolution layers will be described in accordance with the flowchart of FIG. 3B. In the flowchart of FIG. 3B, products are calculated in order from step S301. When a graph convolution operation is performed, the product of three matrices (an adjacency matrix, a feature matrix, and a parameter matrix) is calculated, and there are two ways to perform the calculation. There are two methods: a method of computing the product of first two matrices first, and then calculating the product of the result of that calculation and the last matrix; and a method of calculating the product of the last two matrices first, and then calculating the product of the result of that calculation with the first matrix.

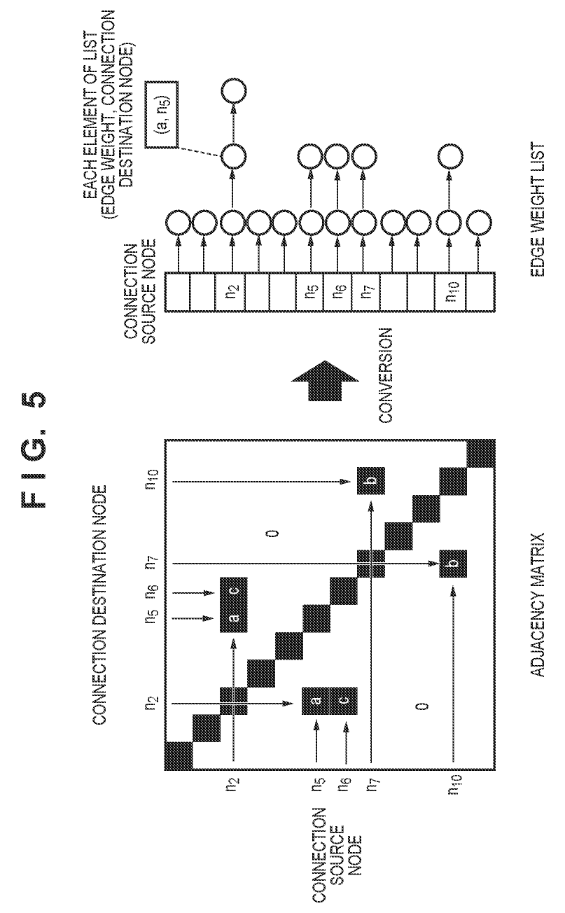

FIGS. 4A and 4B are diagrams illustrating a difference in the number of multiplications according to the order in computing the matrix when the first layer graph convolution operation is performed on the Cora dataset. Due to the difference between the number of input features of the feature matrix (1433 in the first layer) and the number of output features of the graph convolution operation (16 in the first layer), the procedure of FIG. 4B in which the product of the feature matrix and the parameter matrix is computed first and then the product of the adjacency matrix therewith is computed is more computationally efficient than the procedure of FIG. 4A in which the product of the adjacency matrix and the feature matrix is computed first, and then the product with the parameter matrix is computed. Therefore, in the present embodiment, the product is calculated according to the sequence of FIG. 4B.

Note that in the second layer graph convolution operation, since the number of input features is 16 and the number of output features is 7, it is more computationally efficient to perform the calculation in the same order as in FIG. 4B. In this embodiment, instead of using an adjacency matrix, the graph convolution operation is performed using the edge weight list generated in step S300; this does not change the order of multiplications based on the matrix computation order, and yields the same computation results as when using an adjacency matrix.

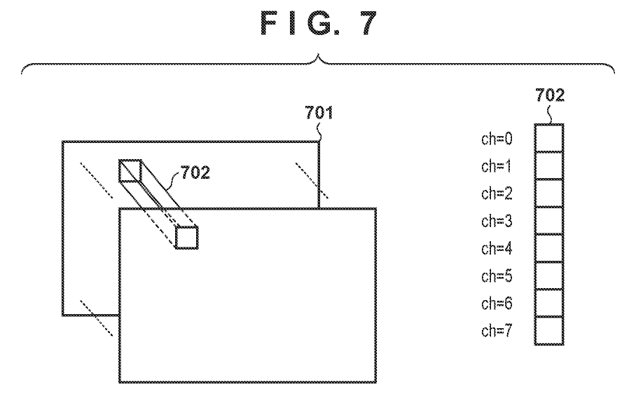

In step S301, the multiply and accumulate unit 203 computes a product of the feature matrix X0 and the parameter matrix W1. The computation of the product of the feature matrix and the parameter matrix will be described using FIG. 6A.

First, the reading unit 201 reads one piece of feature data from the feature matrix X. Next, the reading unit 202 reads a plurality of coefficient data corresponding to the feature data from the parameter matrix W. The number of coefficient data to be read is the same as the number of parallel calculations of the multiply and accumulate unit 203, and in the present embodiment, an example in which four items are read at a time is described. Since it is a matrix calculation, in order to compute the elements of the intermediate matrix XW to be outputted, the feature matrix advances by one column in the horizontal direction, and the parameter matrix advances in the vertical direction, while reading multiple sets of four coefficient data items that are consecutive in the horizontal direction.

The multiply and accumulate unit 203 performs multiplication and accumulation (i.e., a multiply-accumulate operation) using the four coefficient data items and the feature data. When the feature data reaches the right end of the feature matrix and the coefficient data reaches the lower end of the parameter matrix, the computation is completed for four elements of the intermediate matrix, and thus the multiply and accumulate unit 203 outputs a multiply-accumulate operation result ("each element of the intermediate matrix") to the duplication unit 204.

The duplication unit 204 repeats the multiply-accumulate operation result four times, which corresponds to the degree of parallelism, and outputs the result to the post-processing unit 205. The post-processing unit 205 sequentially selects the respective multiply-accumulate operation results output from the duplication unit 204, and outputs the selected multiply-accumulate operation results to the subsequent writing unit 206.

The writing unit 206 completes the intermediate matrix XW by setting each multiply-accumulate operation result (element of the intermediate matrix) outputted from the post-processing unit 205 to the corresponding element in the intermediate matrix, and stores the intermediate matrix XW in the data memory.

The multiply and accumulate unit 203 performs a large number of operations in parallel, but requires a number of cycles corresponding to the width of the feature matrix to calculate one matrix element (1433 in the case of the first layer Cora dataset). On the other hand, the post-processing unit 205 takes 4 cycles in the present embodiment because processing cycles are only required in proportion to the degree of parallelism of the multiply and accumulate unit 203. The duplication unit 204 holds a plurality of multiply-accumulate operation results, and repeatedly outputs the multiply-accumulate operation results, so that even when the degree of parallelism of the post-processing unit 205 and the degree of parallelism of the multiply and accumulate unit 203 are different, data flows without delay and maximal processing performance is achieved, respectively.

In step S302, the multiply and accumulate unit 203 computes a product of the intermediate matrix X0W1 generated in step S301 and the edge weight list, and the post-processing unit 205 performs Relu processing on each element (each feature) in the matrix obtained from the product.

Using FIG. 6B, a method for computing a product of an intermediate matrix and an edge weight list will be described. First, the reading unit 201 reads one element from the edge weight list obtained by compressing the adjacency matrix. The element of the edge weight list stores edge weight data and information (connection destination node information) indicating the connection destination node. Of this information, the edge weight data is outputted to the multiply and accumulate unit 203. Further, the connection destination node information is outputted to the reading unit 202.

The reading unit 202 generates address information (access destination) of the intermediate matrix XW to be accessed using the connection destination node information as the read destination information. Based on this address information, it is possible to read a plurality of pieces of data in which the data (feature data) of the intermediate matrix in the data memory is consecutive in the horizontal direction. Therefore, while access to the intermediate matrix is random access, consecutive data in the horizontal direction can be efficiently acquired. The plurality of read data is outputted to the multiply and accumulate unit 203. Thereafter, as in the explanation of step S301, multiplication/accumulation of the data of the corresponding intermediate matrix and the edge weight data is performed. When the end of the list for one connection source node in the edge weight list is reached, the multiply-accumulate operation is completed for a number of elements corresponding to the degree of parallelism of the multiply and accumulate unit 203. When all the elements cannot be generated by one operation for one connection source node, the edge weight list is read again, the intermediate matrix is accessed, and the multiply-accumulate operation is performed.

The duplication unit 204 repeatedly outputs the multiply-accumulate operation result. Since the lengths of the list for the respective connection source nodes of the edge weight list are different, the number of cycles to be processed by the multiply and accumulate unit 203 varies, but the duplication unit 204 buffers the data flow to compensate for the performance difference between the multiply and accumulate unit 203 and the post-processing unit 205. The post-processing unit 205 sequentially executes Relu processing when the multiply-accumulate operation results are outputted from the duplication unit 204.

Thereafter, the writing unit 206 completes a feature matrix X1 by setting the respective multiply-accumulate operation results (the elements of the feature matrix X1 representing the result of the graph convolution operation of the first layer) outputted from the post-processing unit 205 to the corresponding elements in the feature matrix X1.

In step S303, the multiply and accumulate unit 203 computes the product of the feature matrix X1 and the parameter matrix W2 in the same manner as in step S301 described above. In step S304, the multiply and accumulate unit 203 computes (generates) a feature matrix X2 representing the result of the second layer graph convolution operation by the product of the intermediate matrix X1W2 generated in step S303 and the edge weight list by the same processing as in step S302 described above. Then, the writing unit 206 writes the feature matrix X2 into the data memory.

In step S305, as described above, the CPU 103 performs classification by assigning the category corresponding to the feature with the highest likelihood among the respective components of the feature matrix X2 generated in step S304 as the category of the paper (node).

As described above, according to the present embodiment, it is possible to realize an efficient graph convolution operation by omitting redundant operations, by data access based on the readout destination information of the edge weight list without having a large-capacity adjacency matrix. As described above, by efficiently executing the graph convolution operation, it is possible to suppress the power consumption and the processing time of the computation unit that performs the graph convolution operation to the minimum required.

In addition, in the present embodiment, an example in which the degree of parallelism of the multiply and accumulate unit is 4, and data is read accordingly has been described, but it is possible to shorten the processing time of the graph convolution operation in proportion to the degree of parallelism of the multiply and accumulate unit.

Further, since the duplication unit can absorb the difference in the processing time between the multiply and accumulate unit and the post-processing unit, it is possible to maximize the respective processing performances. In particular, the graph structure enables efficient processing even if the lengths of the edge weight list are different.

### Second Embodiment

In the present embodiment, differences from the first embodiment will be described, and it will be the same as the first embodiment unless otherwise mentioned below. In this embodiment, a case will be described in which, in a feature map of a CNN in which a feature vector is defined for each grid point, as with image data, a graph convolution is performed using a graph generated by training these feature vectors.

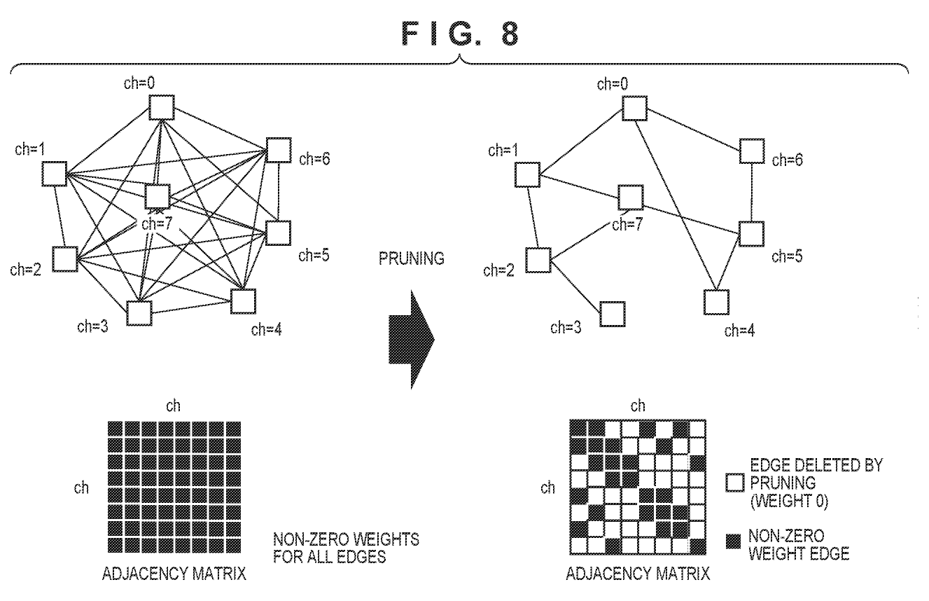

While convolution in a spatial direction and a feature direction on image data is carried out by normal CNNs, research into graph convolution has led to efforts to reduce the computational complexity, while maintaining task accuracy by graph structuring in both the spatial direction and the feature direction. In the present embodiment, graph structuring and a graph convolution operation in the feature direction will be described with respect to one feature vector 702 (feature count=8: ch=0 to 7) of a feature map 701 shown in FIG. 7.

In the graph convolution operation performed in the present embodiment, by regarding each element (each piece of feature data) in the feature vector 702 as one node (the number of features is 1), and structuring edges connecting feature data, a graph is defined. An adjacency matrix composed of feature data represents influences between the feature data items, and appropriate influences between the feature data can be computed by training according to the task to be executed.

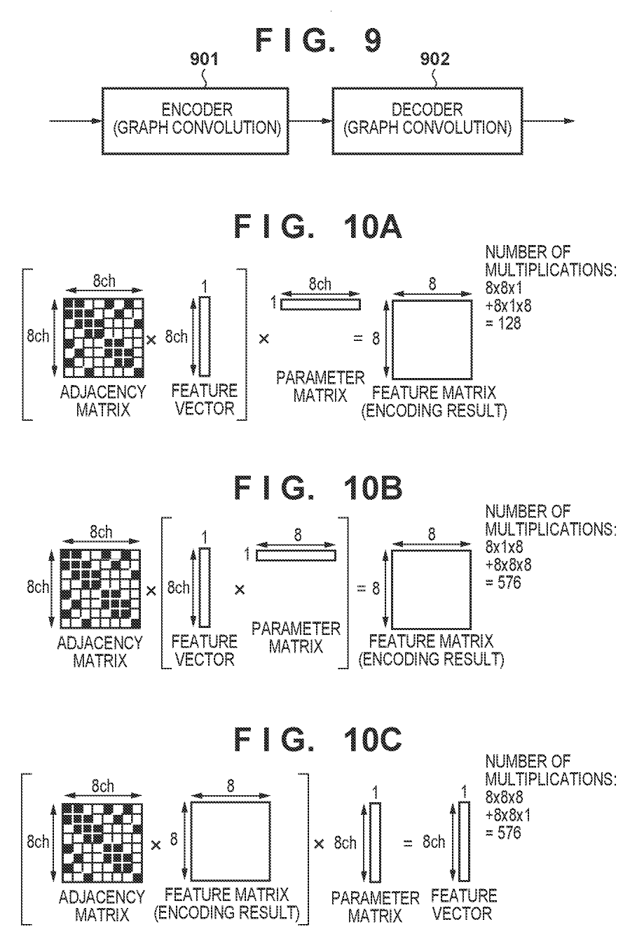

FIG. 8 illustrates a graph and an adjacency matrix in which all the feature data items are interconnected with respect to the feature vector 702, and a result of pruning them. The adjacency matrix on the left side of FIG. 8 trained with all the feature data interconnected may contain redundant information depending on the actual task, and pruning of the adjacency matrix is performed in the same way as pruning CNN weights. The pruning method is realized by, for example, setting a weight of 0 for those for which the absolute value of the edge weight is smaller than a predetermined threshold. Since an edge having an edge weight of 0 can be considered as a deleted edge, a graph having sparse connection relationships is constructed as shown in the graph on the right side of FIG. 8.

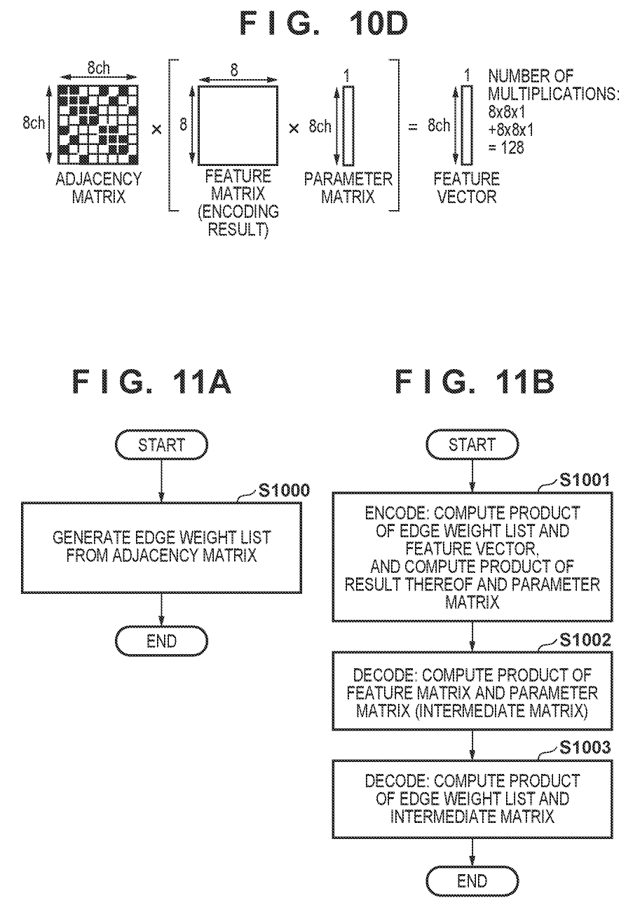

FIG. 9 illustrates a network structure of a graph convolution operation in the present embodiment. Such a network structure can be implemented by the CPU 103 or the computation unit 101. An encoder 901 performs encoding (graph convolution) on the feature vector 702 having 8 features to obtain an encoding result (feature matrix) of 8×8. A decoder 902 decodes (graph convolution) the result of encoding by the encoder 901 to obtain a feature vector having 8 features.

By this two-layer graph convolution operation, it is possible to perform a convolution operation on each feature vector of the feature map 701 in the feature direction. The graph convolution operation of the present embodiment is an operation for which the different feature vectors of the feature map 701 are independent of each other, and thus can be processed in parallel.

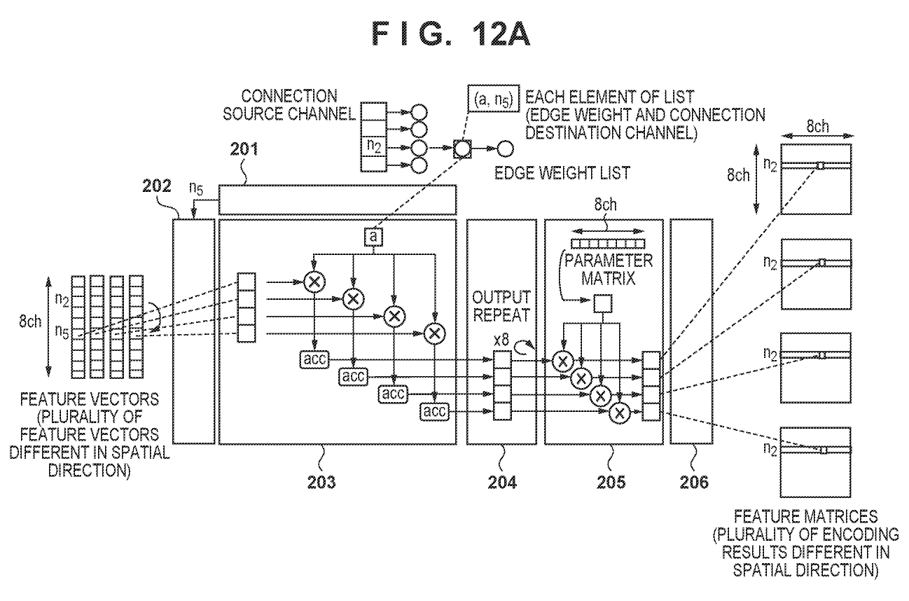

FIG. 10A to 10D illustrate matrix computation amounts according to the computation order, and as shown in FIGS. 10A and 10B, in encoding by the encoder 901, it is more efficient to perform the operation (product) on the adjacency matrix and the feature vector first. Further, as shown in FIGS. 10C and 10D, in decoding by the decoder 902, it is more efficient to perform the operation (product) on the feature matrix and the parameter matrix first. In these cases, an efficient computation order is determined by the magnitude relationship between the number of input features and the number of output features.

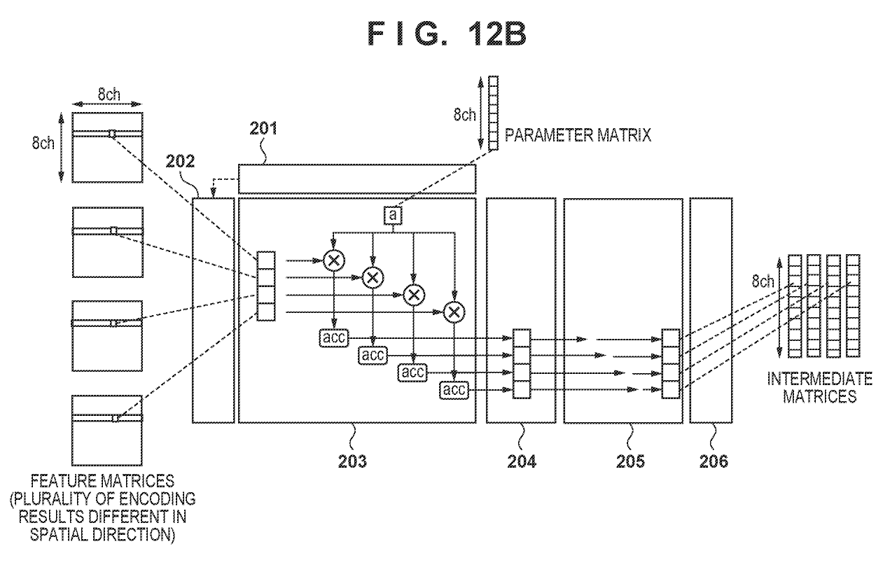

Next, the processing performed by the information processing apparatus will be described in accordance with the flowcharts of FIGS. 11A and 11B. First, preliminary preparatory processing performed prior to inference will be described in accordance with a flowchart of FIG. 11A. In step S1000, the CPU 103 generates an edge weight list from the adjacency matrix in the same manner as in step S300 described above.

Next, operations of the above-described encoder 901 and decoder 902 will be described in accordance with a flowchart of FIG. 11B.

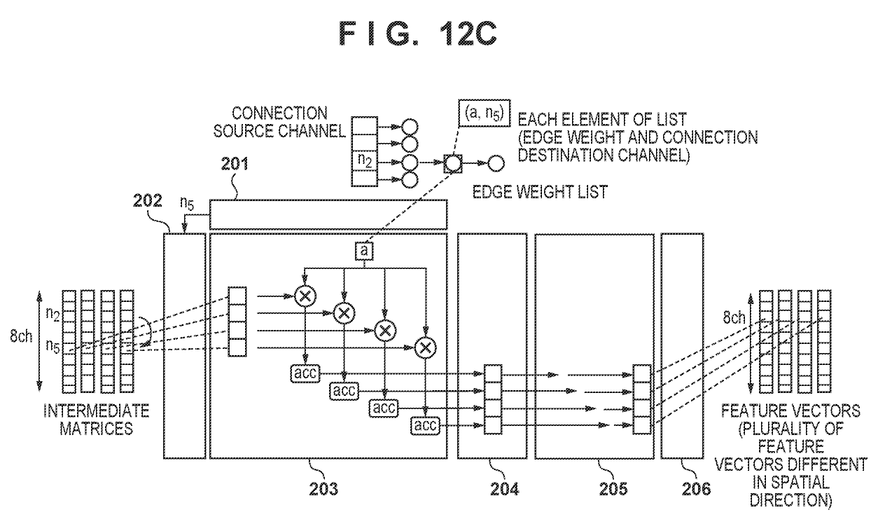

In step S1001, for encoding by the encoder 901, an operation is performed in which a product of the edge weight list and the feature vectors is computed and the product of the result of that product and the parameter matrix is computed. The operation of the computation unit 101 in this step will be described with reference to FIG. 12A. In the encoding by the encoder 901, since the number of output features is larger than the number of input features, it is advantageous to calculate the product of the edge weight list and the feature vectors first, and therefore, this operation is done first.

The reading unit 201 reads the elements one by one from the edge weight list, and reads, from the elements, the edge weight and the connection destination channel which serves as read destination information in the reading unit 202. The connection destination channel is outputted to the reading unit 202, and the addresses to be read from the feature vectors are determined. Feature data is simultaneously read from a plurality of feature vectors that are different in the spatial direction of the feature map 701. The number of pieces of feature data to be read at the same time depends on the degree of parallelism of the multiply and accumulate unit 203. The multiply and accumulate unit 203 performs a multiply-accumulate operation on the edge weight and the corresponding feature data. When the end of the edge weight list is reached for each connection source channel, the multiply-accumulate operation is completed, and the result is outputted to the duplication unit 204. The duplication unit 204 duplicates the same value according to the number of channels of the parameter matrix (eight times in the present embodiment) and outputs the values to the post-processing unit 205. The post-processing unit 205 of the present embodiment is configured to multiply each multiply-accumulate operation result by a coefficient data item of the parameter matrix, and configuration is such that the product of the product of the edge weight list and the feature vector and the parameter matrix is calculated in the post-processing unit 205. The encoding result calculated by the post-processing unit 205 is written to a desired address by the writing unit 206. The computation unit 101 of the present embodiment can perform processing without writing out the intermediate data encoded by the encoder 901 to an external unit, by copying and processing the intermediate data by the duplication unit 204. Also, configuration may be such that the parameter matrix is read out from an external coefficient memory without being held by the post-processing unit 205.

In step S1002, for decoding by the decoder 902, an operation of calculating a product of the feature matrices and the parameter matrix and computing an intermediate matrix is performed. In the decoding by the decoder 902, it is advantageous in terms of computation amount to calculate the product of the feature matrices and the parameter matrix first, and therefore, processing is performed in that order. The operation of the computation unit 101 in this step will be described with reference to FIG. 12B.

First, the reading unit 201 reads one parameter matrix from the coefficient memory. The reading unit 202 reads the corresponding feature data from a plurality of spatial encoding results. The results computed by the multiply and accumulate unit 203 are written into desired intermediate matrices by the writing unit 206 via the duplication unit 204 and the post-processing unit 205.

In step S1003, a process of computing a product of the edge weight list and the intermediate matrices computed in step S1002 is performed as the second half of the decoding processing by the decoder 902. As shown in FIG. 12C, the reading unit 202 reads the intermediate matrices based on the read destination information in the edge weight list, and the results of the multiply-accumulate operation are written out by the writing unit 206. As a result, the decoding results by the decoder 902 can be obtained simultaneously as a plurality of feature vectors.

In this way, processing can be executed having switched to the appropriate order of processing in accordance with the relative number of input/output features of the matrices for performing the graph convolution. The control unit 207 may switch the order of the processing flow to an order set in advance in accordance with a magnitude relationship of the number of input/output features, or may automatically detect the number of input/output features and then switch the order of the processing flow.

As described above, according to the present embodiment, by performing processing in an appropriate order in accordance with the number of input/output features of the graph convolution operation, efficient computation can be performed. In addition, conventionally, in a data structure such as an edge weight list on which random access is performed, it is difficult to increase the degree of parallelism because address decoding is required in proportion to the number of parallel reads. On the other hand, in the case where spatially different feature graphs are processed in parallel as in the present embodiment, if feature data to be accessed all at once are arranged so as to be consecutive, efficient data transfer can be performed and the degree of parallelism can be increased.

### Third Embodiment

In the present embodiment, differences from the second embodiment will be described, and it will be the same as the second embodiment unless otherwise mentioned in particular below. In the present embodiment, an example will be described in which, when a graph convolution operation is performed hierarchically, a graph structure to be applied is generated from a feature matrix that is an output result of a graph convolution operation of a previous layer.

Studies have been carried out on structured data such as image data by spatial direction and feature direction graph structuring to reduce computational complexity. In graph structuring, in addition to examples of computation by the deep learning technology performed in advance, there are cases of generation from an intermediate feature map in which graph convolution is performed hierarchically. The present embodiment illustrates that an edge weight list indicating a graph structure can be efficiently generated from an intermediate feature map as described above.

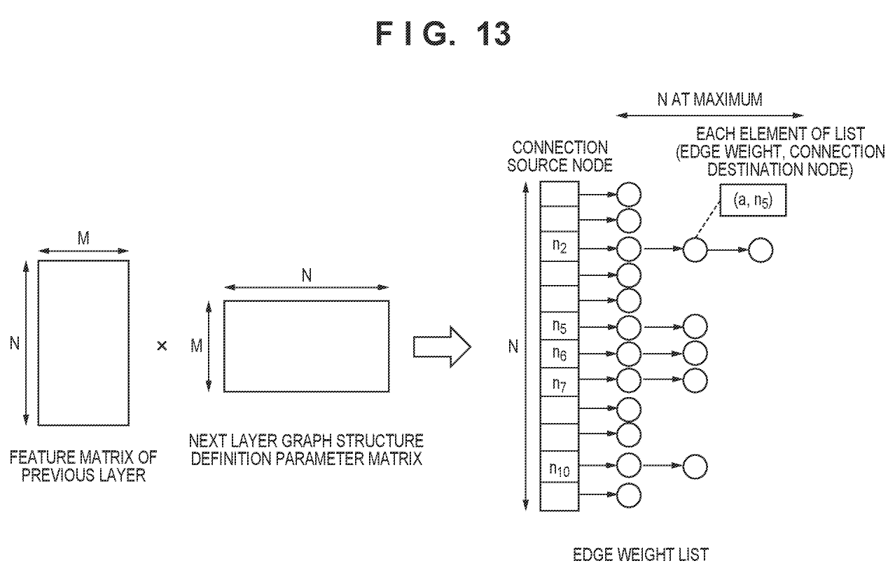

FIG. 13 is a conceptual diagram illustrating a method of generating an edge weight list. The edge weight list is generated from an N×M feature matrix (N and M: natural numbers), which is the output result of the previous layer, and an M×N parameter matrix for defining the graph structure which is trained in advance. Here, the natural number N indicates the number of nodes of the target graph structure, and in the case of image data, the number of pixels, the number of channels described in the second embodiment, and the like is N. The natural number M indicates the number of dimensions of the feature vector for each node. From these matrices, an edge weight list of the next layer is generated by an operation. The edge weights constituting the elements of the edge weight list are computed by a convolution operation on a parameter matrix trained in advance and a feature matrix of a previous layer.

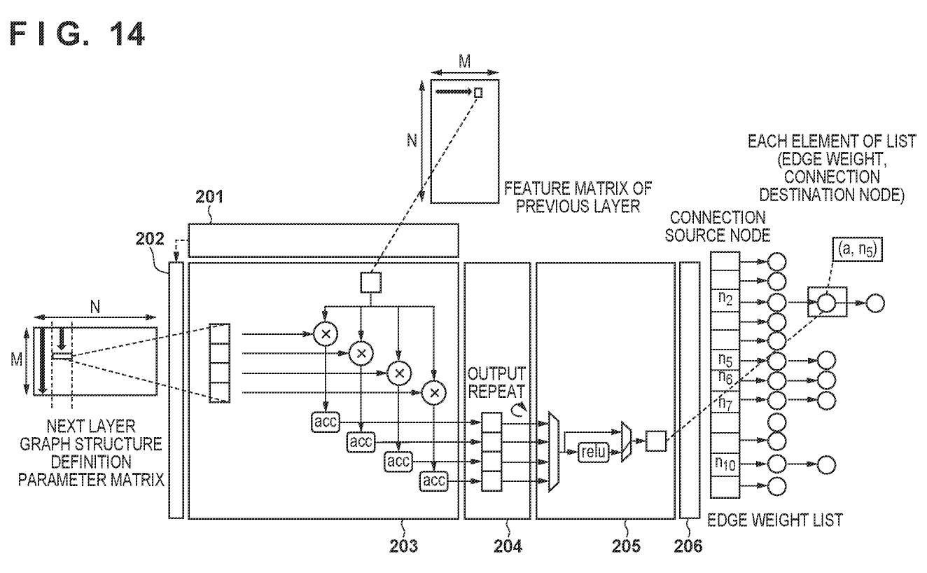

In the present embodiment, the computation unit 101 computes the edge weight list. The operation of the computation unit 101 will be described with reference to FIG. 14. The behavior of the present embodiment illustrated in FIG. 14 is processing similar to the method for computing the product of the feature matrix and the parameter matrix in the first embodiment described in FIG. 6A. In the convolution operation, the data of the feature matrix is read out one row at a time, and four pieces of coefficient data of the parameter matrix consecutive in the horizontal direction are read out down to the lower end of the matrix, and an accumulative addition is performed. The duplication unit 204 repeatedly outputs the four cumulative added values, and the post-processing unit 205 performs Relu processing. Further, when the result of the Relu processing is 0 (when the multiply-accumulate operation result is a negative number), the writing unit 206 does not write out the result, and when the result of the Relu processing is a non-zero value, the Relu processing result is outputted together with the coordinate value indicating the position on the horizontal axis N in the parameter matrix indicating the connection destination node of the graph structure. By repeating this operation, an edge weight list can be generated. Since the edge weight list generated here is used in the graph convolution operation of the next layer, it is desirable that each element of the edge weight list be written into consecutive memory regions. Therefore, repeatedly, after up to four elements are written, the data of the same row of the feature matrix is read one by one again, and four pieces of coefficient data adjacent in the horizontal direction of the parameter matrix are read down to the lower end of the matrix. When the processing of the coefficient data set of the parameter matrix is completed up to the right end of the matrix, for the edge weight list, all elements are written into consecutive elements in the memory by lowering the row of the feature matrix to be read out by one and repeating the above.

As described above, it is possible to generate a graph structure from the feature matrix by a definition by which a place where the edge weight becomes a negative number by Relu processing produces a node which is not connected in the graph structure, and training a parameter matrix for defining the graph structure.

In addition, by writing only the edge weights that are non-zero in the edge weight list, there is a possibility that a graph structure can be generated with a smaller memory capacity than an adjacency matrix that always requires a capacity corresponding to the number of nodes × the number of nodes. In addition, a decrease in the number of writes can reduce power consumption.

In each of the above-described embodiments, the case in which all of the functional units in FIG. 2 are implemented by hardware has been described, but some of the functional units may be implemented by software. For example, the reading unit 201, the reading unit 202, the multiply and accumulate unit 203, the duplication unit 204, the post-processing unit 205, and the writing unit 206 may be implemented by software (computer program). In such a case, the CPU 103 and the control unit 207 execute the computer program to realize the functions of the corresponding functional units.

The numerical values, the processing timings, the processing order, the subject of the processing, the data configuration/acquisition method/transmission destination/transmission source/storage location (information), and the like used in the above-described embodiments are given as examples for the purpose of concrete explanation, and are not intended to be limited to such examples.

In addition, some or all of the above-described embodiments may be appropriately combined and used. In addition, some or all of the above-described embodiments may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-171514, filed September 30, 2024, and Japanese Patent Application No. 2025-112523, filed July 2, 2025 which are hereby incorporated by reference herein in their entirety.

What is claimed is:

1. An information processing apparatus for performing a graph convolution operation on a graph, the apparatus comprising:
a first acquisition unit configured to acquire from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph;
a second acquisition unit configured to acquire, based on the connection destination, data to be inputted into a computing unit from among computation target data; and
a computation unit configured to use the computing unit to perform an operation using the data acquired by the second acquisition unit and the weight of node acquired by the first acquisition unit.

2. The information processing apparatus according to claim 1, wherein the second acquisition unit, based on the connection destination, generates address information of the data to be inputted into the computing unit from among the computation target data, and acquires the data to be inputted into the computing unit based on that address information.

3. The information processing apparatus according to claim 1, wherein the computation target data is a result of a multiply-accumulate operation on feature data of nodes of the graph and trained parameters.

4. The information processing apparatus according to claim 3, wherein
in a case where the number of channels of the feature data is more than the number of channels of a computation result of the computation unit, the computation target data is a result of a multiply-accumulate operation on feature data of nodes of the graph and trained parameters, and
in a case where the number of channels of the feature data is less than the number of channels of the computation result of the computation unit, the computation target data is feature data of nodes of the graph.

5. The information processing apparatus according to claim 1, wherein the computation unit applies a Relu function to a result of a multiply-accumulate operation on the data acquired by the second acquisition unit and the weight of the node acquired by the first acquisition unit.

6. The information processing apparatus according to claim 5, wherein the computation unit applies the Relu function to a result of a multiply-accumulate operation for a first of two graph convolution layers.

7. The information processing apparatus according to claim 1, further comprising a classification unit configured to, based on a result of the operation by the computation unit, perform a category classification on the graph.

8. The information processing apparatus according to claim 7, wherein the classification unit performs the category classification based on a result of the operation by the computation unit for the second of two graph convolution layers.

9. The information processing apparatus according to claim 1, further comprising a duplication unit configured to hold a multiply-accumulate result by the computation unit and repeatedly output the same result.

10. The information processing apparatus according to claim 1, wherein the computation unit performs parallel processing on a plurality of feature vectors in different spaces of a feature map.

11. The information processing apparatus according to claim 1, wherein the first acquisition unit acquires the list, which is structured to list elements in which a weight of a node in the graph indicating an influence between nodes and a connection destination of data to which that weight from a connection source node to a connection destination node is applied in a convolution form a pair, having excluded elements for which there is no connection between nodes in the graph structure.

12. The information processing apparatus according to claim 11, wherein the first acquisition unit reads the list from consecutive regions in memory.

13. The information processing apparatus according to claim 1, wherein the computation unit performs a convolution operation using the data acquired by the second acquisition unit and the weight of the node acquired by the first acquisition unit, and outputs a non-zero graph weight and a connection destination of data corresponding to that weight.

14. The information processing apparatus according to claim 13, wherein the computation unit writes, in consecutive regions in memory, elements in which a weight of a node of the graph and a connection destination of data corresponding to that weight form a pair.

15. An information processing method performed by an information processing apparatus for performing a graph convolution operation on a graph, the method comprising:
acquiring from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph;
acquiring, based on the connection destination, data to be inputted into a computing unit from among computation target data; and
using the computing unit to perform an operation using the acquired data and the acquired weight of node.

16. A non-transitory computer-readable storage medium storing a computer program for causing a computer operable to perform a graph convolution operation on a graph to function as:
a first acquisition unit configured to acquire from a list comprising weights of nodes of the graph and connection destinations of those nodes and for which information of the portion, in an adjacency matrix representing connection relationships of nodes in the graph, where values representing the connection relationships are non-zero has been extracted, a weight and a connection destination of a node of the graph;
a second acquisition unit configured to acquire, based on the connection destination, data to be inputted into a computing unit from among computation target data; and
a computation unit configured to use the computing unit to perform an operation using the data acquired by the second acquisition unit and the weight of node acquired by the first acquisition unit.
